(19) United States
(12) Patent Application Publication
(10) Pub. No.: US 2026/0320765 A1
(43) Pub. Date: Oct. 15, 2026

(54) INFORMATION PROCESSING APPARATUS, INFORMATION PROCESSING METHOD, AND STORAGE MEDIUM

(71) Applicant: CANON KABUSHIKI KAISHA, Tokyo (JP)

(72) Inventor: AIKA FUNAKUBO, Kanagawa (JP)

(21) Appl. No.: 19/577,151

(22) Filed: Mar. 24, 2026

(30) Foreign Application Priority Data
Apr. 15, 2025 (JP) 2025-066657

(51) Int. Cl. G06T 7/00; G06F 40/166; G06T 11/60

(52) U.S. Cl. CPC G06T 7/0002; G06F 40/166; G06T 11/60; G06T 2207/30184

(57) ABSTRACT

An information processing apparatus includes one or more hardware processors and one or more memories storing instructions that can be executed by the one or more hardware processors. The instructions include instructions for acquiring a defect detection result obtained by detecting a defect in a structure from a structure image of the structure as a subject; acquiring a finding statement regarding the defect included in the structure image; accepting a requirement for a determination rationale for structural soundness of the structure from a user; generating, by using a generation artificial intelligence model, text indicating the determination rationale based on the defect detection result, the finding statement, and the requirement; and outputting the text.

### BACKGROUND

### Field of the Technology

The present disclosure relates to an information processing apparatus, an information processing method, and a storage medium.

### DESCRIPTION OF THE RELATED ART

The concrete surfaces of bridges and buildings may have defects, such as cracks and water leakage. In order to detect structural failures caused by such defects at an early stage and carry out repairs, local government inspectors diagnose the structural soundness of the structure and record the structural soundness classification in the inspection report.

Japanese Patent Laid-Open No. 2022-56218 describes a technique for determining a structural soundness classification of a structure based on rule-based assessment criteria including the presence or absence of a defect, the type of the defect, and the size of the defect, and outputting information on the defect and criteria that served as the rationale for determining the structural soundness classification. The defect information and the determination criteria output by this technique may be insufficient to serve as the determination rationale that the new inspection guidelines require to be included in inspection reports.

International Publication No. WO 2017/047315 describes a technology for calculating the degree of damage impact, which indicates the impact of damage on the structure, for each damaged part, based on the relative positional relationship between the critical parts of the structure and the damaged parts, and determining the structural soundness classification of the structure based on the degree of damage impact. However, how these indicators will affect the future structural soundness of the structure is not output as text.

In the prior art, no means has been considered for describing a determination rationale statement for a structural soundness classification.

### SUMMARY

According to an aspect of the present disclosure, an information processing apparatus includes one or more hardware processors and one or more memories storing instructions that can be executed by the one or more hardware processors. The instructions include instructions for acquiring a defect detection result obtained by detecting a defect in a structure from a structure image of the structure as a subject; acquiring a finding statement regarding the defect included in the structure image; accepting a requirement for a determination rationale for structural soundness of the structure from a user; generating, by using a generation artificial intelligence model, text indicating the determination rationale based on the defect detection result, the finding statement, and the requirement; and outputting the text.

Features of the various embodiments will become apparent from the following description of embodiments with reference to the attached drawings. The following description of embodiments is described by way of example.

### BRIEF DESCRIPTION OF THE DRAWINGS

FIG. 1 is a hardware configuration diagram of a computer.

FIG. 2 is a configuration diagram of an information processing apparatus that detects a defect of a structure according to a first embodiment.

FIG. 3 is a diagram illustrating defect information in the first embodiment.

FIG. 4 is a diagram illustrating finding statement information in the first embodiment.

FIG. 5 is a diagram illustrating an example of a finding statement/individual assessment rating display screen of an image analysis system according to the first embodiment.

FIG. 6 is a diagram illustrating an example of a content instruction screen for a determination rationale statement for a structural soundness classification in the image analysis system according to the first embodiment.

FIG. 7 is a diagram illustrating information for generating a determination rationale statement for a structural soundness classification and an output result in the image analysis system according to the first embodiment.

FIG. 8 is a diagram illustrating an example of a determination rationale display screen for a structural soundness classification in the image analysis system according to the first embodiment.

FIGS. 9A and 9B are flowcharts for generating a determination rationale statement for a structural soundness classification in the image analysis system according to the first embodiment.

### DESCRIPTION OF THE EMBODIMENTS

Hereinafter, embodiments according to the present disclosure will be described in detail with reference to the accompanying drawings. It should be noted that the following embodiments are merely examples for realizing the present disclosure and are not intended to limit the claims.

### FIRST EMBODIMENT

In the present embodiment, an information processing apparatus will be described which inputs, into a generation artificial intelligence (AI), information on a defect that has occurred in a specific area of a structure, a finding statement on the defect, and an instruction statement for specifying the requirements to be included in a determination rationale statement, and acquires the determination rationale statement.

Examples of the structure here include highways, bridges, tunnels, dams, and the like, and examples of the defect include cracks and water leakage that occur on the concrete surface of the structure due to damage, deterioration, or other factors. A crack is linear damage having a starting point, an end point, a length, and a width that occurs on the wall surface of a structure due to aging deterioration, the shock of an earthquake, or the like. Water leakage refers to a state in which water enters through cracks or gaps formed in concrete due to factors such as rain, and water leaks out from the concrete.

Defects such as cracks and water leakage can occur on the concrete surfaces of bridges and buildings due to a variety of factors. Since structural failures caused by such defects need to be detected and repaired at an early stage, the national government requires local governments to conduct regular inspections. Local government inspectors regularly check for defects that have occurred in structures based on the road bridge inspection guidelines issued by the national government and the inspection guidelines established by each local government. Inspectors conduct a structural soundness diagnosis indicating the degree to which the defect has affected the function of the structure and the need for repairs, compile the results into a report and submit the report to the national government. For example, the road bridge inspection guidelines issued by the national government define structural soundness classification categories as follows:
I: A state in which the function of the structure is not impaired.
II: A state in which the function of the road bridge is not impaired, but it is desirable to take preventive measures.
III: A state in which the function of the road bridge may be impaired, and early measures should be taken.
IV: A state in which the function of the road bridge is impaired or there is a very high possibility of impairment, and urgent measures should be taken.

Conventionally, the structural soundness classification was written in inspection reports. However, in recent inspections, differences in the diagnostic criteria for structural soundness among local governments and differences in the skill levels of inspection contractors have resulted in variations in the accuracy of the results of structural soundness diagnoses. For example, in a case where similar defects occur in structures of the same material and the same configuration, the diagnostic results for structural soundness may differ depending on the local government conducting the inspection. Therefore, in the new inspection guidelines scheduled to be revised by the Ministry of Land, Infrastructure, Transport and Tourism in 2024, the national government requires local governments to include the determination rationale for structural soundness diagnoses in inspection reports. The determination rationale for a structural soundness diagnosis is assumed to be a statement including, for example, the following content:
(1) The internal damage conditions of the structure inferred from its external appearance
(2) Outlook of progression of the damage occurring in the structure
(3) The impact of the current damage occurring in a part of the structure on the entire structure and other members, and the estimated durability of the structure and the possibility of harm to third parties
(4) Whether or not repair measures are urgently needed

In order for inspectors to prepare inspection reports in accordance with the new inspection guidelines, they need to include a determination rationale statement for the structural soundness classification as described above. However, no means has been considered for efficiently writing the determination rationale statement for the structural soundness classification required under the new inspection guidelines, and inspectors need to manually write the determination rationale statement from scratch.

In an information processing apparatus according to the present embodiment, defect information on the structure, a finding statement, and a content instruction statement indicating the requirements to be included in the determination rationale statement are input to a generation AI to acquire the determination rationale statement. This reduces the burden on the inspectors when writing the determination rationale statement on the structural soundness classification of the structure in the inspection report.

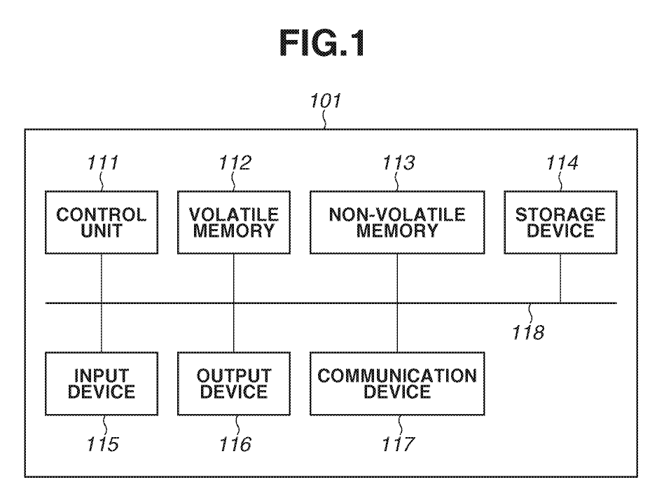

First, an example of the hardware configuration of the information processing apparatus according to the present embodiment will be described with reference to FIG. 1. In the embodiment described below, a computer device operates as the information processing apparatus.

An information processing apparatus 101 includes a control unit 111, a volatile memory 112, a non-volatile memory 113, a storage device 114, an input device 115, an output device 116, a communication device 117, and a system bus 118.

The control unit 111 includes a central processing unit (CPU), a micro processing unit (MPU) and an arithmetic processing processor that controls the entire information processing apparatus 101.

The volatile memory 112 is a random access memory (RAM) that temporarily stores programs and data supplied from external devices or the like.

The non-volatile memory 113 is a read-only memory (ROM) that stores programs to be executed by the processor of the control unit 111 and parameters. The non-volatile memory 113 records an operating system (OS), which is the basic software to be executed by the control unit 111, and applications that work with the OS to implement applied functions.

The storage device 114 is an internal device such as a hard disk or memory card built in the information processing apparatus 101, or an external device such as a hard disk or memory card detachably connected to the information processing apparatus 101. The storage device 114 includes a hard disk or memory card formed of a semiconductor memory, a magnetic disk, or the like. The storage device 114 also includes a storage medium including a disk drive that reads and writes data from and to optical discs such as digital versatile discs (DVDs) and Blu-ray discs.

The input device 115 is an operating member such as a mouse, a keyboard, or a touch panel that accepts user operations and outputs operation instructions to the control unit 111.

The output device 116 is a display device such as a display or a monitor formed of a liquid crystal display (LCD) or organic electroluminescence (EL), and displays data stored in the information processing apparatus 101 and data supplied from external devices.

The communication device 117 is communicably connected to a network such as the Internet or a local area network (LAN).

The system bus 118 includes an address bus, a data bus, and a control bus that connect the components of the information processing apparatus 101 so as to enable data exchange.

The processing performed by the information processing apparatus 101 according to the present embodiment is implemented by reading software provided by an application. The application is assumed to include software for using the basic functions of the OS installed in the information processing apparatus 101. The OS of the information processing apparatus 101 may include software for implementing the processing according to the present embodiment.

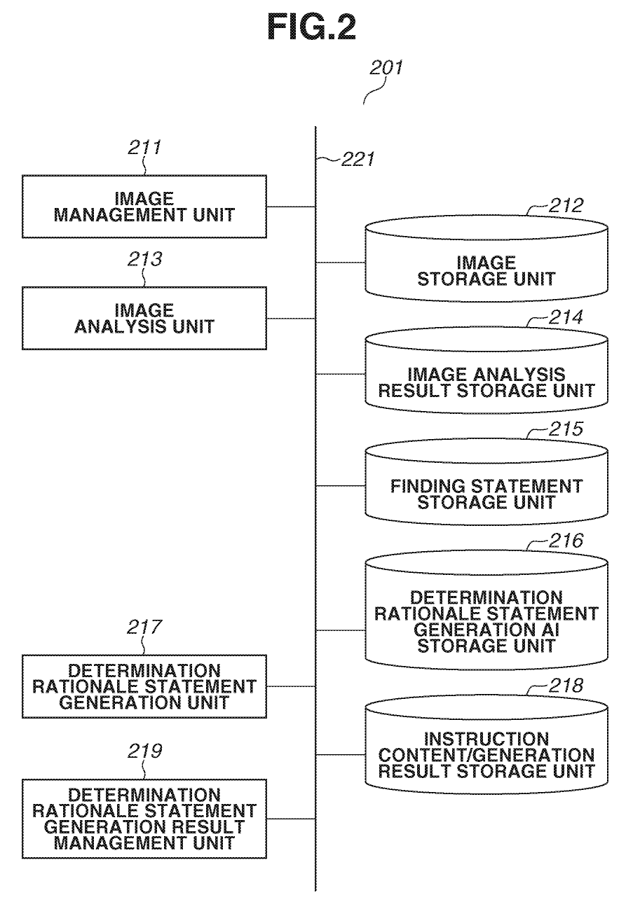

Next, an example of the system configuration of the information processing apparatus 101 according to the present embodiment will be described with reference to FIGS. 2 to 8.

FIG. 2 illustrates an example of the configuration of an image analysis system that detects defects of a structure in the first embodiment. A system configuration 201 of the information processing apparatus 101 includes functional units described below, which are connected to one another by a system bus 221. The information processing apparatus 101 includes an image management unit 211, an image storage unit 212, an image analysis unit 213, an image analysis result storage unit 214, and a finding statement storage unit 215. The information processing apparatus 101 further includes a determination rationale statement generation AI storage unit 216, a determination rationale statement generation unit 217, an instruction content/generation result storage unit 218, and a determination rationale statement generation result management unit 219. Each functional unit of the information processing apparatus 101 is implemented by hardware and software. Each functional unit may be configured by one or more computer devices or server devices, and may be configured as a system connected via a network.

The image storage unit 212 has a function of storing data of inspection images that are subjected to defect detection. The inspection images uploaded by users to the system are stored in the image storage unit 212. An inspection image here is a structure image of a structure that is a subject.

The image management unit 211 has a function of presenting the inspection images stored in the image storage unit 212 to the user in a list or one by one in detail via the output device 116, and a function of deleting inspection images stored in the image storage unit 212 from the image storage unit 212.

The image analysis unit 213 has a function of executing image analysis on the inspection image to be subjected to defect detection using a learning model created by machine learning and deep learning, and detecting defects that have occurred in the structure that is the subject of the inspection image.

The image analysis result storage unit 214 has a function of storing the inspection image on which defect detection has been executed and the defect information obtained through detection by the image analysis unit 213 in association with each other.

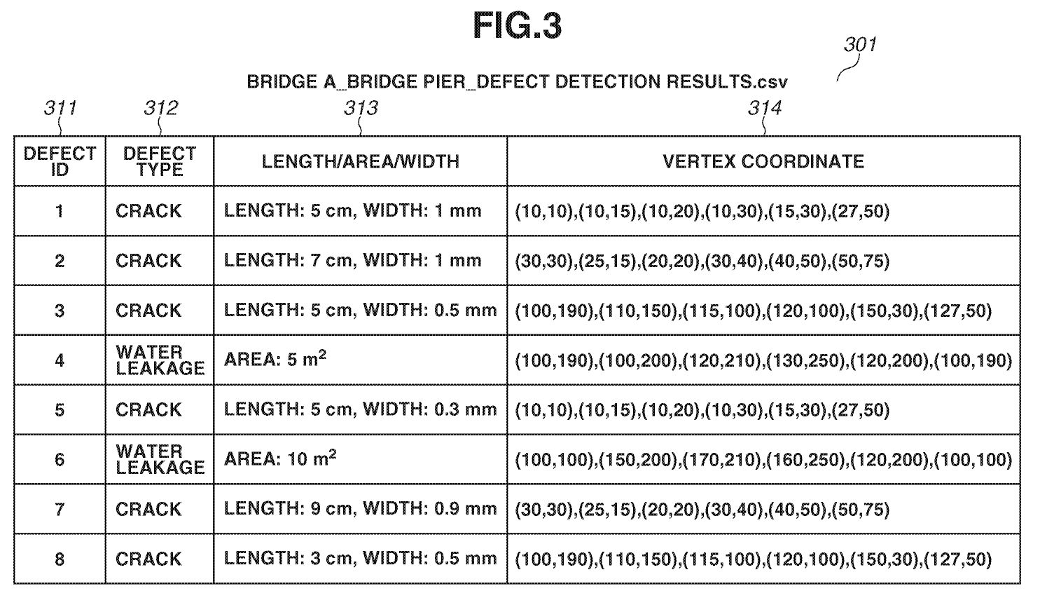

FIG. 3 illustrates an example of the defect information stored in the image analysis result storage unit 214.

Defect information 301 consists of vector data including a defect identification (ID) 311, defect type 312, dimension information 313, and vertex coordinate information 314, which is stored in a format such as Comma Separated Values (CSV) or Drawing Exchange Format (DXF). The defect ID 311 is an ID for identifying a defect, and the defect type 312 indicates the type of a defect, such as a crack or water leakage, corresponding to the defect indicated by each defect ID. The dimension information 313 indicates the area and damage width of the defect in an inspection image. For example, if one end of a detected crack is assumed to be the origin, the length and width from the origin to the other end of the crack are expressed in millimeters. The defect information 301 is created for each inspection image.

The finding statement storage unit 215 has a function of storing a finding statement for one or more defects that have occurred in the structure and the information of the target defect in association with each other. The finding statement is text data that describes the characteristics of each defect, predictions of future progression of the defect, and the impact on the surroundings.

An individual assessment rating of each defect may be stored together with the finding statement in the finding statement storage unit 215. The individual assessment rating is a classification of the degree of a defect based on the dimensional information of the damage of the structure and the overlap with other types of defects, and is assigned to each piece of defect information. The criteria for determining the individual assessment rating are based on the road inspection guidelines of the national government and each local government.

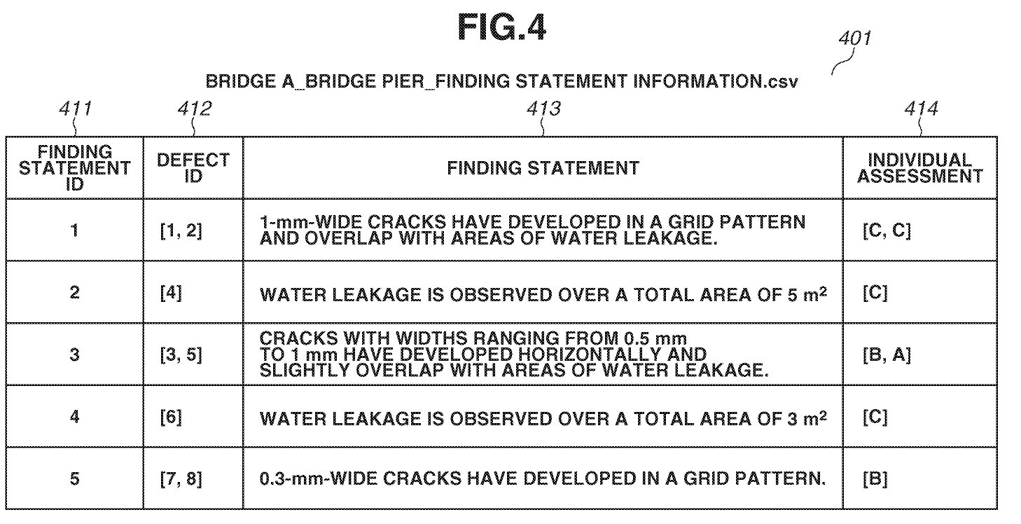

FIG. 4 illustrates an example of the finding statement information stored in the finding statement storage unit 215. The finding statement information 401 includes a finding statement ID 411 that identifies a finding statement, a defect ID list 412 of the defect IDs 311 of the defects mentioned in the finding statement, text data 413 of the finding statement, and a list 414 of individual assessment ratings associated with the defect IDs 311. The finding statement information 401 is created for each inspection image and stored in a format such as CSV.

The finding statement information 401 can be prepared by various methods. For example, as a finding statement acquisition means, the information processing apparatus 101 may include a user interface that allows an inspector to specify a defect and enter a finding statement corresponding to the specified defect. The information processing apparatus 101 may accept uploading of a CSV file of finding statement information created by the inspector for each defect. The finding statement information 401 or a portion thereof may be written out based on the detected defect information, using a generation AI or other technology included in the system.

The individual assessment rating list 414 includes a list of individual assessment ratings corresponding to defect IDs in the same order as the defect IDs in the defect ID list 412. For example, if the defect ID list 412 contains [1, 2] in this order, the individual assessment rating list 414 contains [individual assessment rating of defect ID 1, individual assessment rating of defect ID 2] in this order. If there is a defect that has been assigned a defect ID but has not been assigned an individual assessment rating, the rating of the defect may be set as empty data, or may contain some data indicating that the rating is empty data.

The determination rationale statement generation AI storage unit 216 stores a trained AI model. As a preliminary step, the user prepares a generation AI model called a base model. This is an AI model that learns a large amount of data from a wide range of fields, and generates and outputs answers to questions from humans. The user further trains the prepared AI model through machine learning such that the AI model generates determination rationale statements desired by the user. The AI model is trained by using, for example, defect information, finding statements associated with the defects, environmental conditions under which the structure or the defects are placed, traffic volume information such as the number of vehicles passing by per day, and determination rationale statements written by humans for the defects.

The determination rationale statement generation unit 217 generates a determination rationale statement for the structural soundness classification. The determination rationale statement generation unit 217 has a function of displaying a finding statement/individual assessment rating display screen 501 and a content instruction screen 601 on the output device 116.

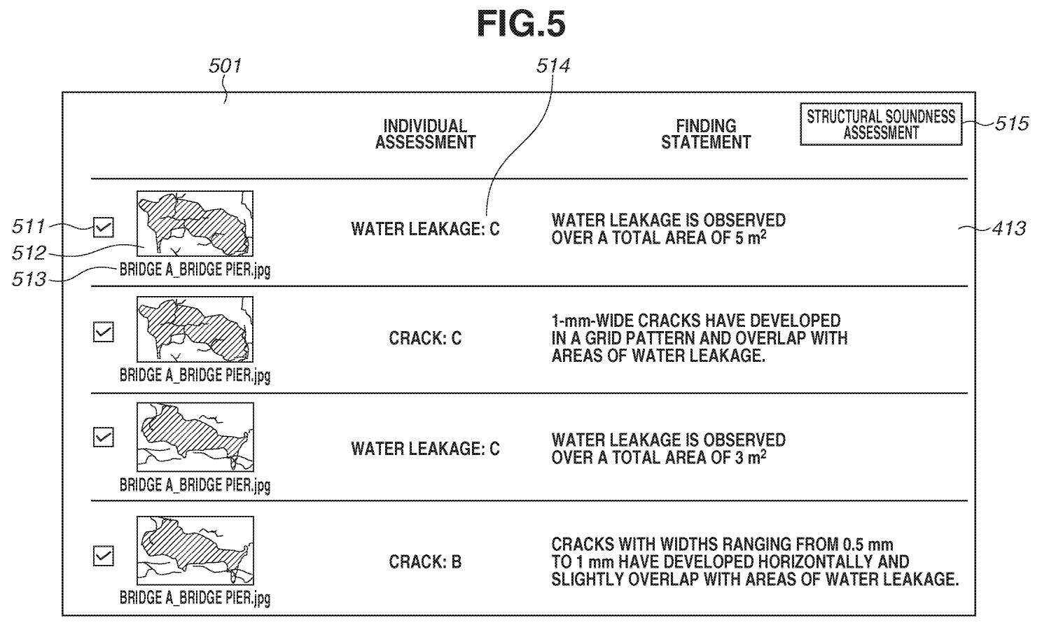

FIG. 5 illustrates an example of the finding statement/individual assessment rating display screen 501 displayed on the output device 116. The finding statement/individual assessment rating display screen 501 includes finding statements 413, selection boxes 511, defect detection result images 512, defect detection result image names 513, individual assessment ratings 514, and a content instruction screen transition button 515. The user can select information used for generating a determination rationale statement using the finding statement/individual assessment rating display screen 501.

The selection boxes 511 are selection boxes for selecting a finding statement to be used for generating a determination rationale statement from the plurality of finding statements 413 displayed on the finding statement/individual assessment rating display screen 501. The finding statements 413 used for generating a determination rationale statement are not limited to a single finding statement, and a plurality of finding statements may be selected as finding statements to be used for generating a determination rationale statement.

Each defect detection result image 512 is an inspection image of a defect whose defect ID is included in the defect ID list 412 associated with the finding statement 413 in the finding statement information 401. The entire image may be displayed as a thumbnail, or a portion of the image in which the defect appears may be cut out and displayed as a thumbnail.

Each defect detection result image name 513 is a name of the corresponding defect detection result image 512.

Each individual assessment rating 514 may display, as a representative rating, the highest individual assessment rating among the individual assessment ratings corresponding to the defects whose defect IDs are included in the defect ID list 412 associated with the finding statement, or all the individual assessment ratings determined for the respective defects may be displayed. If the individual assessment rating is empty data, the individual assessment rating 514 may be left blank, or may display some kind of indication that the rating is empty.

The content instruction screen transition button 515 is a button used to transition the screen from the finding statement/individual assessment rating display screen 501 to the content instruction screen 601, and is activated when one or more selection boxes 511 are selected. When the user selects the content instruction screen transition button 515, the screen displayed on the output device 116 transitions from the finding statement/individual assessment rating display screen 501 to the content instruction screen 601.

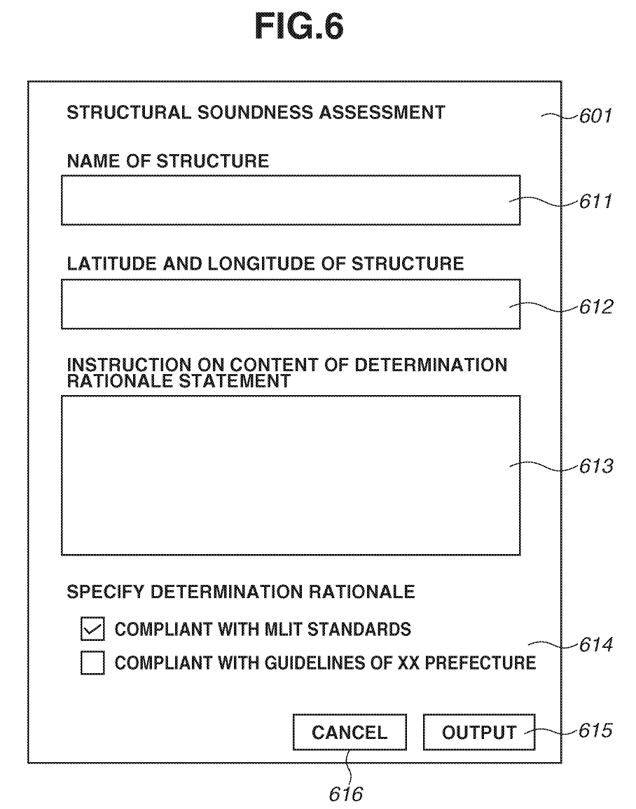

FIG. 6 is a diagram illustrating an example of the content instruction screen 601 displayed on the output device 116. The content instruction screen 601 includes a structure name input section 611, a structure location information input section 612, a content instruction prompt input section 613, a structural soundness determination criterion selection section 614, a structural soundness determination rationale statement output button 615, and a cancel button 616.

The structure name input section 611 is an input field for inputting the name of the structure to be subjected to defect detection. The name of the structure may be input directly by using a device such as a keyboard, or the name of the structure to be subjected to defect detection may be selected from a list of the names of a plurality of structures.

The structure location information input section 612 is an input field for inputting the location information of the structure that is subjected to defect detection. The location information refers to information specified by latitude and longitude, for example. The location information may be input directly by using a device such as a keyboard, or the location information of the target structure may be selected from a list of a plurality of pieces of location information. Alternatively, the location of the target structure may be selected from a map displayed on the content instruction screen 601.

In this way, when the structure to be subjected to defect detection can be identified based on the name of the structure input into the structure name input section 611 or the location information of the structure input into the structure location information input section 612, the structural specification data can be acquired and used for determining the structural soundness.

The content instruction prompt input section 613 is an input field for inputting a prompt for causing the generation AI stored in the determination rationale statement generation AI storage unit 216 to generate a determination rationale statement. The user inputs, into the content instruction prompt input section 613, a prompt that instructs points to be particularly considered as the content of the determination rationale statement and content to be included in the output.

The control unit 111 may, while displaying the content instruction screen 601 on the output device 116, call the AI model from the determination rationale statement generation AI storage unit 216 in advance and cause the AI model to analyze the text input into the content instruction prompt input section 613. The control unit 111 may provide the user with a recommendation that information on the material of the structure, environmental conditions around the structure, information on defects in neighboring parts, and the like, which are necessary to further improve the accuracy of the structural soundness assessment, may be included in the determination rationale statement, and may prompt the user to input such information into the content instruction prompt input section 613. This makes it possible to enrich the information necessary for generating a determination rationale statement, and generate the determination rationale statement more accurately.

In the example illustrated in the present embodiment, the content instruction prompt input section 613 is free format. However, for information important for structural soundness assessment, such as material information of the structure, the surrounding environment, and information on the defect to be particularly considered, a dedicated input field may be provided in the content instruction prompt input section 613 to allow the user to input such information. Furthermore, the content instruction prompt may be determined by dividing an example of the content instruction prompt into a plurality of parts according to clauses, displaying the parts separately, and allowing the user to select parts to be included in the content instruction prompt. By causing the information processing apparatus 101 to present to the user the content to be input into the AI model, the user can use the information processing apparatus 101 more easily.

In the structural soundness determination criterion selection section 614, the user specifies one of the inspection guidelines issued by the Ministry of Land, Infrastructure, Transport and Tourism or the inspection guidelines issued by each local government, which is to be used as the determination rationale. Here, a configuration is adopted in which the determination rationale to be conformed to is selected from two examples of determination rationales. Alternatively, a configuration is adopted in which the user can input the inspection guidelines that serve as candidates for the determination rationale in advance, and select the determination rationale to be conformed to in the determination from the input determination rationale examples.

The structural soundness determination rationale statement output button 615 is a button for outputting a structural soundness determination rationale statement corresponding to the content input into the content instruction screen 601. The cancel button 616 is a button for canceling the process without outputting a structural soundness determination rationale statement. When the structural soundness determination rationale statement output button 615 is selected, the AI model stored in the determination rationale statement generation AI storage unit 216 generates a determination rationale statement.

The content input into the finding statement/individual assessment rating display screen 501 and the content instruction screen 601, and the determination rationale statement generated by the AI model stored in the determination rationale statement generation AI storage unit 216 are stored in the instruction content/generation result storage unit 218 as structural soundness assessment information.

In addition to the structure name, structure location information, content instruction prompt, and structural soundness assessment criteria described above, the content instruction screen 601 may also have a function of specifying a unit of output for the text of the determination rationale statement, for example. The structural soundness assessment may be performed for each member of the structure in some cases, and it may be performed for the entire structure in some other cases. By allowing the user to specify the unit of output for the text, it is possible to output a determination rationale statement that conforms to the writing style of an inspection report, so that the user can create the inspection report more efficiently.

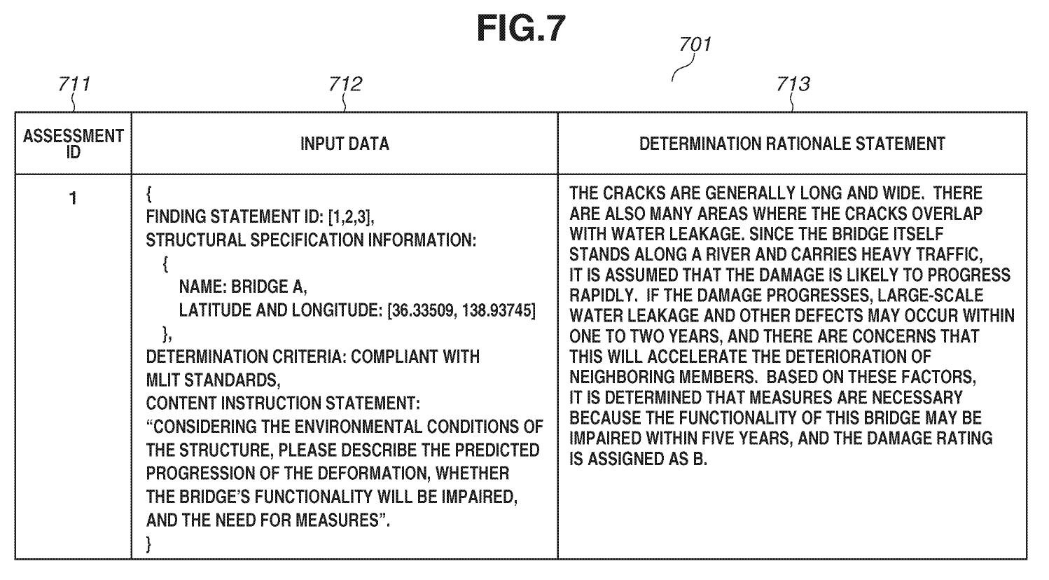

FIG. 7 illustrates an example of structural soundness assessment information stored in the instruction content/generation result storage unit 218.

The structural soundness assessment information 701 includes a structural soundness assessment ID 711, input data 712, and a determination rationale statement 713.

The structural soundness assessment ID 711 is an ID that is assigned when the user selects the content instruction screen transition button 515 on the content instruction screen 601. The structural soundness assessment ID 711 may have a randomly generated value, or may have a value that follows a specific rule.

The input data 712 includes a list of the finding statement IDs 411 associated with the defect selected by the selection box 511, and the content input into each of the structure name input section 611, the structure location information input section 612, the content instruction prompt input section 613, and the structural soundness determination criterion selection section 614.

The determination rationale statement 713 is text data of a determination rationale statement that is the output result obtained by inputting the input data 712 into the AI model stored in the determination rationale statement generation AI storage unit 216.

The determination rationale statement generation result management unit 219 has a function of displaying to the user the determination rationale statement 713 stored in the instruction content/generation result storage unit 218 on a determination rationale statement display screen 801 displayed via the output device 116.

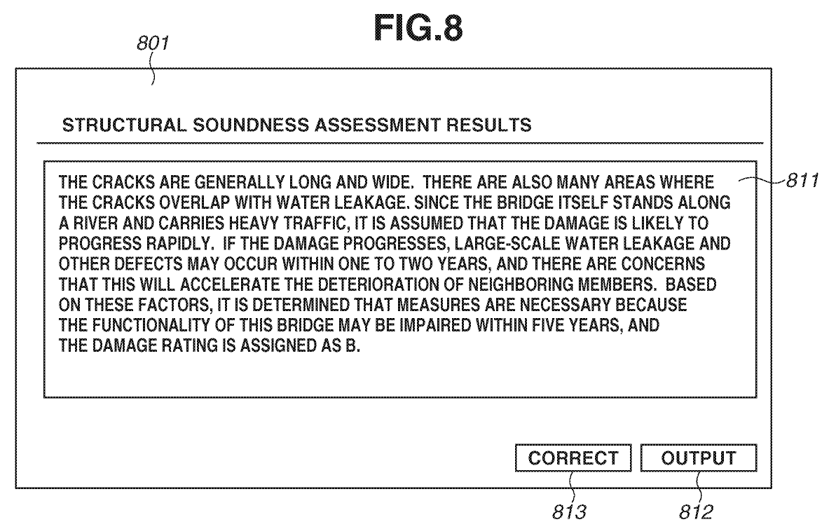

FIG. 8 illustrates an example of the determination rationale statement display screen 801 that presents to the user the determination rationale statement 713 stored in the instruction content/generation result storage unit 218. The determination rationale statement display screen 801 includes a determination rationale statement display section 811, a determination rationale statement output button 812, and a determination rationale statement correction button 813, and is an example of an output means for outputting a determination rationale statement.

The determination rationale statement generation result management unit 219 displays the determination rationale statement 713 stored in the instruction content/generation result storage unit 218 in the determination rationale statement display section 811. The determination rationale statement 713 displayed in the determination rationale statement display section 811 can be corrected by the user by pressing the determination rationale statement correction button 813. The determination rationale statement 713 may be corrected directly in the determination rationale statement display section 811, or a dedicated screen may be provided for correction.

In the example of the determination rationale statement display screen 801 illustrated in FIG. 8, the determination rationale statement 713 is displayed in a single determination rationale statement display section 811. Alternatively, for example, the determination rationale statement 713 may be divided into a plurality of parts according to clauses, and the respective parts may be displayed in a plurality of determination rationale statement display sections 811. By outputting the determination rationale statement divided into parts corresponding to "internal condition inferred from the external appearance", "outlook of damage progression", "impact of the current damage on the entire bridge and other members", and "other information", it is possible to provide the user with important content as the determination rationale statement in a particularly easy-to-understand manner. Furthermore, it may be possible to edit, such as correcting or deleting, each part of the determination rationale statement. The correction of a determination rationale statement may be performed in cooperation with a system dedicated to correction.

The corrected determination rationale statement 713 may be automatically stored at regular intervals, for example.

Furthermore, an interface such as a button indicating that the correction has been completed may be provided, and the determination rationale statement 713 may be overwritten and stored when the user operates the interface.

In response to the user selecting the determination rationale statement output button 812, the determination rationale statement generation result management unit 219 outputs the determination rationale statement as a text file.

In the above description, the determination rationale statement display screen 801 has been described to display only the determination rationale statement 713, the determination rationale statement output button 812, and the determination rationale statement correction button 813. The determination rationale statement display screen 801 may have an image output means, and specifically may display a structure image in which a defect related to the determination rationale statement 713 appears, or an image in which the structure image and the defect detection result are superimposed. In this case, a thumbnail of the entire structure image may be displayed, or the defect part in the image may be cut out and displayed. This allows the inspector to immediately confirm the defect part mentioned in the generated determination rationale statement and to easily check whether the determination rationale statement is correct.

Furthermore, the AI model may be caused to output several candidates for the determination rationale statement, and the candidates may be displayed on the determination rationale statement display screen 801. In this case, the user may be allowed to select which determination rationale statement to adopt on the determination rationale statement display screen 801, output the selected determination rationale statement, and correct the selected determination rationale statement.

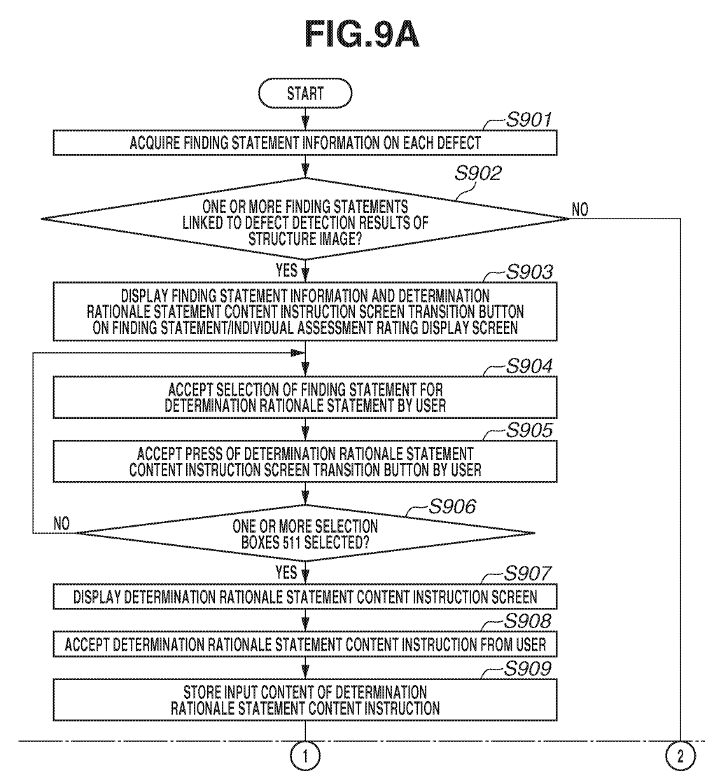

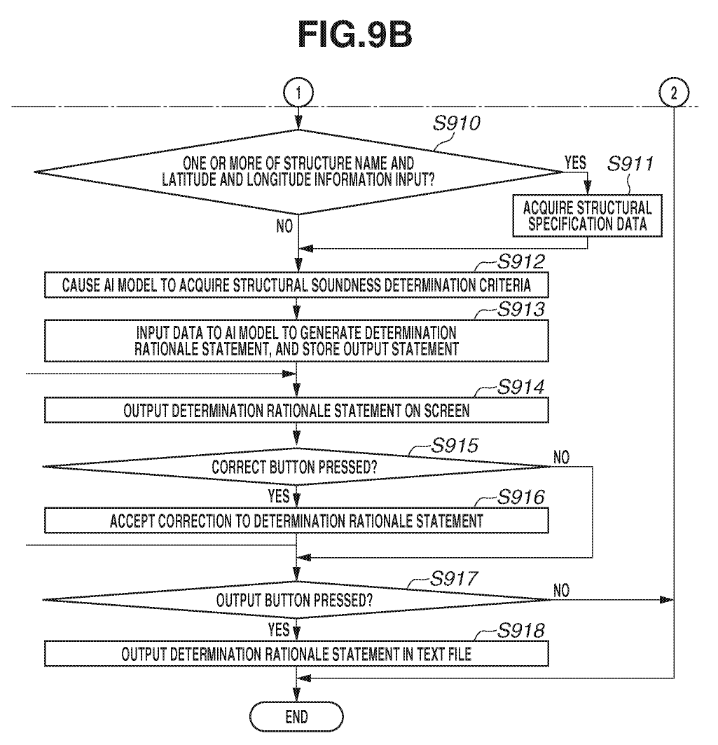

FIGS. 9A and 9B are flowcharts illustrating a process of providing a user with a determination rationale statement for a structural soundness classification by the information processing apparatus according to the present embodiment.

In step S901, the control unit 111 acquires the finding statement information 401 from the finding statement storage unit 215.

In step S902, the control unit 111 checks whether one or more finding statements are stored in the finding statement information 401 acquired in step S901 and whether one or more finding statements are linked to the defect detection results of the structure image. If one or more finding statements are stored (YES in step S902), the process proceeds to step S903, and if not (NO in step S902), the process is ended.

In step S903, the control unit 111 displays to the user the finding statement information and the content instruction screen transition button 515 on the finding statement/individual assessment rating display screen 501 displayed on the output device 116. The finding statement information refers to, for example, the finding statements 413, the selection boxes 511, the defect detection result images 512, the defect detection result image names 513, and the individual assessment ratings 514.

In step S904, the control unit 111 accepts a user operation of selecting one or more selection boxes 511 on the finding statement/individual assessment rating display screen 501.

In step S905, the control unit 111 accepts a user operation of pressing the content instruction screen transition button 515, and in response to the pressing of the content instruction screen transition button 515, the process proceeds to step S906.

In step S906, the control unit 111 determines whether one or more selection boxes 511 have been selected on the finding statement/individual assessment rating display screen 501. If one or more selection boxes 511 have been selected (YES in step S906), the process proceeds to step S907, and if none of the selection boxes 511 has been selected (NO in step S906), the process returns to step S904. At this time, the control unit 111 prompts the user to select one or more selection boxes 511. The notification to the user may be made via the output device 116, or may be made by means of voice or the like.

In step S907, the control unit 111 displays the content instruction screen 601 to the user via the output device 116, and then the process proceeds to step S908. At this time, the control unit 111 assigns the structural soundness assessment ID 711. The control unit 111 also stores, in the input data 712, the information on the finding statement ID 411 associated with the selection box selected in step S904 in a linked manner to the structural soundness assessment ID 711.

In step S908, the control unit 111 accepts a determination rationale statement content instruction from the user. For example, the control unit 111 accepts the content input by the user into each of the structure name input section 611, the structure location information input section 612, the content instruction prompt input section 613, and the structural soundness determination criterion selection section 614 displayed on the content instruction screen 601, and then the process proceeds to step S909.

In step S909, the control unit 111 adds the information accepted in step S908 to the input data 712 linked to the structural soundness assessment ID 711 stored in step S907, and stores again the structural soundness assessment information 701.

In step S910, the control unit 111 determines whether the input data 712 re-stored in step S909 includes either or both of the structure name input into the structure name input section 611 or the structure location information input into the structure location information input section 612. If at least one of the structure name or the structure location information is included (YES in step S910), the process proceeds to step S911. If neither of them is included (NO in step S910), the process proceeds to step S912.

In step S911, the control unit 111 acquires specification data of the structure using at least one of the structure name and the structure location information. The acquired specification data of the structure is temporarily stored in the volatile memory 112. The specification data here refers to information such as past structural inspection conditions and measures taken for the structure, traffic volume, the year of construction, the bridge type, and the structural form. These pieces of information are generally published via the Internet, and the data can be acquired by identifying the structure using the structure name and the location information.

In step S912, the determination rationale statement generation unit 217 acquires the AI model stored in the determination rationale statement generation AI storage unit 216. The determination rationale statement generation unit 217 further acquires the content of the structural soundness determination criteria input into the structural soundness determination criterion selection section 614 in step S908 via the communication device 117. The acquired structural soundness determination criteria are temporarily stored in the volatile memory 112.

In step S913, the determination rationale statement generation unit 217 acquires information to be input into the AI model. Specifically, the determination rationale statement generation unit 217 acquires the input data 712 stored in the instruction content/generation result storage unit 218 in step S909, the specification data temporarily stored in the volatile memory 112 in step S911, and the content of the structural soundness assessment criteria temporarily stored in the volatile memory 112 in step S912. The determination rationale statement generation unit 217 inputs the acquired information into the AI model. The control unit 111 stores the determination rationale statement output by the AI model as the determination rationale statement 713 of the structural soundness assessment information 701, and the process proceeds to step S914.

In step S914, the control unit 111 displays to the user the determination rationale statement stored as the determination rationale statement 713 on the determination rationale statement display screen 801.

In step S915, the control unit 111 determines whether a user operation of pressing the correction button 813 on the determination rationale statement display screen 801 has been accepted. If the user has pressed the correction button 813 (YES in step S915), the process proceeds to step S916, and if the user has not pressed the correction button 813 (NO in step S915), the process proceeds to step S917.

In step S916, the control unit 111 accepts a correction of the determination rationale statement made by the user.

The control unit 111 overwrites the determination rationale statement 713 of the structural soundness assessment information 701 with the corrected text, and the process proceeds to step S914.

In step S917, the control unit 111 determines whether a user operation of selecting the determination rationale statement output button 812 on the determination rationale statement display screen 801 has been accepted. If the user has pressed the determination rationale statement output button 812 (YES in step S917), the process proceeds to step S918. If the user has not pressed the determination rationale statement output button 812 (NO in step S917), the process is ended.

In step S918, the control unit 111 outputs the determination rationale statement 713 in a text file and provides the output text file to the user, and the process is ended.

With the above system, when an inspector prepares a report, a determination rationale statement for an appropriate structural soundness classification can be automatically generated from defect detection results and finding statements, thereby reducing the burden of writing the determination rationale statement.

### Other Embodiments

In step S912 of the first embodiment, the control unit 111 causes the AI model to output the structural soundness assessment criteria via the communication device 117. The structural soundness assessment criteria may be registered in a storage unit within the system in advance, for example, by accepting a file containing the content of the structural soundness assessment criteria uploaded by the user. In this case, in step S912, the control unit 111 acquires the content of the structural soundness assessment criteria registered in advance, and the process proceeds to step S913. This method eliminates the need to prepare instruction text to cause the AI model to acquire the content of the structural soundness assessment criteria with high accuracy as a preliminary preparation, and also eliminates the need for training the AI model to cause the AI model to acquire the content of the structural soundness assessment criteria.

Furthermore, it may be a burden for the user to input content instruction text from scratch into the content instruction prompt input section 613 of the content instruction screen 601. Therefore, information on the finding statements and defect detection results linked to the selection boxes 511 selected by the user on the finding statement/individual assessment rating display screen 501 may be input into the AI model to output the content instruction text and display them in advance in the content instruction prompt input section 613. In this case, it is necessary to input the defect detection results and finding statements to the AI model to train the AI model in advance such that it can output the content instruction prompt statements (text data). This reduces the burden on the user when inputting content instruction text into the content instruction prompt input section 613.

It should be noted that the step of correcting the determination rationale statement 713 and the step of outputting the determination rationale statement 713 in a text file are not essential. The step of setting the structural soundness assessment criteria is also not essential, and for example, the AI model may be trained with the content of the structural soundness assessment criteria in advance during AI learning.

Embodiments of the present disclosure may also be realized by executing the following processing. That is, software (e.g., a program) that implements the functions of the above-described embodiments is supplied to a system or apparatus via a network or various storage media, and the computer (or CPU, MPU, or the like) of the system or apparatus reads and executes the software.

Each of the above embodiments merely illustrates an example of concretely implementing the present disclosure, and the technical scope of the present disclosure shall not be construed as being limited thereto.

That is, embodiments of the present disclosure can be implemented in various forms without departing from its technical concept or essential features.

### Other Embodiments

Embodiment(s) of the present disclosure can also be realized by a computer of a system or apparatus that reads out and executes computer-executable instructions (e.g., one or more programs) recorded on a storage medium (which may also be referred to more fully as a 'non-transitory computer-readable storage medium') to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer-executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer-executable instructions. The computer-executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)^{TM}), a flash memory device, a memory card, and the like.

While the present disclosure has described example embodiments, it is to be understood that some embodiments are not limited to the disclosed embodiments. The scope of the following claims is to be accorded the broadest interpretation so as to encompass all such modifications and equivalent structures and functions.

This application claims priority to Japanese Patent Application No. 2025-066657, which was filed on April 15, 2025 and which is hereby incorporated by reference herein in its entirety.

What is claimed is:

1. An information processing apparatus comprising:
one or more hardware processors; and
one or more memories storing instructions that can be executed by the one or more hardware processors, the instructions including instructions for:
acquiring a defect detection result obtained by detecting a defect in a structure from a structure image of the structure as a subject;
acquiring a finding statement regarding the defect included in the structure image;
accepting a requirement for a determination rationale for structural soundness of the structure from a user;
generating, by using a generation artificial intelligence model, text indicating the determination rationale based on the defect detection result, the finding statement, and the requirement; and
outputting the text.

2. The information processing apparatus according to claim 1, wherein the instructions further include instructions for selecting the defect detection result and the finding statement to be used for generating the text from a plurality of defect detection results and a plurality of finding statements.

3. The information processing apparatus according to claim 1, wherein the requirement is text data input by the user.

4. The information processing apparatus according to claim 1, wherein the requirement includes a name of the structure or location information of the structure.

5. The information processing apparatus according to claim 1,
wherein the instructions further include instructions for registering in advance a determination criterion for the structural soundness, and
wherein the requirement includes the determination criterion.

6. The information processing apparatus according to claim 1, wherein the requirement is set such that the determination rationale is differently set for each member of the structure.

7. The information processing apparatus according to claim 1, wherein an image of a defect part related to the text is output together with the text.

8. The information processing apparatus according to claim 7, wherein the instructions further include instructions for outputting an image in which the image of the defect part and the defect detection result are superimposed.

9. The information processing apparatus according to claim 1, wherein, in a case where there is a plurality of determination rationales, a plurality of pieces of text based on the respective determination rationales is output.

10. The information processing apparatus according to claim 1, wherein the text includes at least one of an internal condition of the structure inferred from an external appearance of the structure, an outlook of damage progression of the structure, and an impact of a current damage of a member of the structure on the entire structure or another member.

11. The information processing apparatus according to claim 1, wherein the instructions further include instructions for presenting a candidate for information to be added to the determination rationale in accordance with the accepted requirement.

12. The information processing apparatus according to claim 1, wherein the instructions further include instructions for dividing the text and accepting editing of the determination rationale for each of divided portions of the text.

13. An information processing method comprising:
acquiring a defect detection result obtained by detecting a defect in a structure from a structure image of the structure as a subject;
acquiring a finding statement regarding the defect included in the structure image;
accepting a requirement for a determination rationale for structural soundness of the structure from a user;
generating, by using a generation artificial intelligence model, text indicating the determination rationale based on the defect detection result, the finding statement, and the requirement; and
outputting the text.

14. A non-transitory computer readable storage medium storing computer-executable instructions for causing a computer to perform a control method of an information processing apparatus, the control method comprising:
acquiring a defect detection result obtained by detecting a defect in a structure from a structure image of the structure as a subject;
acquiring a finding statement regarding the defect included in the structure image;
accepting a requirement for a determination rationale for structural soundness of the structure from a user;
generating, by using a generation artificial intelligence model, text indicating the determination rationale based on the defect detection result, the finding statement, and the requirement; and
outputting the text.
